(19) United States
(12) Patent Application Publication
(10) Pub. No.: US 2017/0303608 A1
(43) Pub. Date: Oct. 26, 2017

(54) Flat-Fold Respirator And Method Of Making Same

(71) Applicant: 3M INNOVATIVE PROPERTIES COMPANY, St. Paul, MN (US)

(72) Inventors: Jian Liang Chen, Shanghai (CN); Ryan D. Kracht, West St. Paul, MN (US); Donald S. Oblak, North St. Paul, MN (US); Sharon N. Mitchell, St. Paul, MN (US); Hans Yin, Shanghai (CN); Nitin Mathur, Woodbury, MN (US)

(21) Appl. No.: 15/518,253

(22) PCT Filed: Oct. 16, 2014
(86) PCT No.: PCT/CN2014/088747

§ 371 Date: Apr. 11, 2017

(51) Int. Cl. A41D 13/11; A62B 23/02; A62B 23/06

(52) U.S. Cl. CPC A41D 13/113; A62B 23/025; A41D 13/1161; A62B 23/06

(57) ABSTRACT

One or more embodiments of a respirator and a method of making the respirator are disclosed. The respirator can include a harness (60) including first and second straps (62, 64); a mask body (12) including right and left portions (16, 18) on each side of a centerline (24), where the right and left portions (16, 18) are bounded by a perimeter (24) of the mask body (12); a right tab (30) that extends from a right side perimeter segment (26) of the perimeter (24) of the mask body (12) adjacent the right portion (16); and a left tab (40) that extends from a left side perimeter segment (28) of the perimeter of the mask body (12) adjacent the left portion (18). The first strap (62) of the harness (60) is attached to the right and left tabs (30, 40) at first right and left attachment locations (50, 52), and the second strap (64) is attached to the right and left tabs (30, 40) at second right and left attachment locations (54, 56).

### BACKGROUND

Respirators are commonly worn over a person's breathing passages in at least one of two situations: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that may be harmful to the wearer, for example, in an auto body shop. In the second situation, the respirator is worn in an environment where there is risk of contamination to other persons or things, for example, in an operating room or clean room.

A variety of respirators have been designed to be used in one or both of these situations. Some of these respirators have been categorized as being “filtering face-pieces” because the mask body itself functions as the filtering mechanism. Unlike respirators that use rubber or elastomeric mask bodies with attachable filter cartridges (see, e.g., U.S. Pat. No. RE39,493 to Yuschak et al.) or insert-molded filter elements (see, e.g., U.S. Pat. No. 4,790,306 to Braun), filtering face-piece respirators are designed to have the filter media cover much of the mask body so that there is no need for installing or replacing a filter cartridge. These filtering face-piece respirators commonly come in one of two configurations: molded respirators and flat-fold respirators.

Molded filtering face-piece respirators often include non-woven webs of thermally-bonded fibers or open-work plastic meshes to furnish the mask body with its cup-shaped configuration. Molded respirators tend to maintain the same shape during both use and storage. These respirators, therefore, cannot be folded flat for storage and shipping. Examples of patents that disclose molded, filtering, face-piece respirators include U.S. Pat. No. 7,131,442 to Kronzer et al; U.S. Pat. No. 6,923,182 and U.S. Pat. No. 6,041,782 to Angadjivand et al.; U.S. Pat. No. 4,807,619 to Dyrud et al.; and U.S. Pat. No. 4,536,440 to Berg.

Flat-fold respirators, as the name implies, can be folded flat for shipping and storage. Such respirators can be opened into a cup-shaped configuration for use. Examples of flat-fold respirators are described in U.S. Pat. Nos. 6,568,392 and 6,484,722 to Bostock et al.; and U.S. Pat. No. 6,394,090 to Chen. Some flat-fold respirators have been designed with weld lines, seams, and folds to help maintain their cup-shaped configuration during use. Stiffening members also have been incorporated into panels of the mask body. See, e.g., U.S. Patent Publication Nos. 2001/0067700 and 2010/0154805 to Duffy et al.; and U.S. Design Pat. No. 659,821 to Spoo et al.

Flat-fold respirators have two general orientations when folded flat for storage. In one Configuration—sometimes referred to as a “horizontal” flat-fold respirator—the mask body is folded crosswise such that it has an upper portion and a lower portion. A second type of respirator is referred to as a “vertical” flat-fold respirator because the primary fold is oriented vertically when the respirator is viewed from the front in an upright position. Vertical flat-fold respirators have left and right portions on opposing sides of the vertical fold or a centerline of the mask body.

Filtering face-piece respirators of the kinds described typically include several different components that are joined or assembled together to make an integral unit. These components may include harnesses, exhalation valves, face seals, nose clips, and the like. For example, face seal components are regularly added because they provide a comfortable fit between differing contours of a wearer's face and the respirator mask body and also to accommodate dynamic changes that might render the seal ineffective, such as when a wearer's face is moving while the wearer is speaking.

### SUMMARY

In general, the present disclosure provides various embodiments of respirators that include one or more tabs that extend from a perimeter of a mask body of the respirator.

In one aspect, the present disclosure provides a vertical flat-fold respirator that includes a harness including first and second straps, and a mask body including right and left portions on each side of a centerline, where the right and left portions are bounded by a perimeter of the mask body. The respirator also includes a right tab that extends from a right side perimeter segment of the perimeter of the mask body adjacent the right portion, and a left tab that extends from a left side perimeter segment of the perimeter of the mask body adjacent the left portion. The first strap of the harness is attached to the right and left tabs at first right and left attachment locations, and the second strap is attached to the right and left tabs at second right and left attachment locations. A length of the first strap is no greater than about two times a distance from either the first right or left attachment locations to the centerline as measured in a direction orthogonal to the centerline when the respirator is in a flat configuration.

In another aspect, the present disclosure provides a continuous process for making a vertical flat-fold respirator. The continuous process includes forming a mask body blank. The mask body blank includes right and left portions on each side of a centerline, where the right and left portions are bounded by a perimeter of the mask body blank; a right tab that extends from a right side perimeter segment of the perimeter of the mask body blank adjacent the right portion; and a left tab that extends from a left side perimeter segment of the perimeter of the mask body blank adjacent the left portion. The mask body blank also includes first and second right attachment locations disposed on the right tab and first and second left attachment locations disposed on the left tab. The first right attachment location and the first left attachment location define a first strap path. And the second right attachment location and the second left attachment location form a second strap path. The continuous process also includes positioning a first strap along the first strap path and a second strap along the second strap path, attaching the first strap to the first right and left attachment locations, and attaching the second strap to the second right and left attachment locations. A length of the first strap is no greater than about two times a distance from either the first right or left attachment locations to the centerline as measured in a direction orthogonal to the center line when the respirator is in a flat configuration.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase, and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### Glossary

The terms set forth herein will have the meanings as defined:
“adjacent an upper perimeter segment” means that an element or device is disposed closer to at least a portion of an upper perimeter segment of a perimeter of a mask body than to a central panel, region, or portion of the mask body;
“breathable region” means a region of the respirator that permits a transport of air from the exterior gas space to the interior gas space and vice versa;
“clean air” means a volume of atmospheric ambient air that has been filtered to remove contaminants;
“contaminants” means particles (including dusts, mists, and fumes) and/or other substances that generally may not be considered to be particles (e.g., organic vapors, etc.) but which may be suspended in air;
“crosswise dimension” is the dimension that extends laterally across the respirator, from side-to-side when the respirator is viewed from the front;
“cup-shaped configuration” and variations thereof mean any vessel-type shape that is capable of adequately covering the nose and mouth of a wearer;
“elastic” in reference to a strap of a harness means being able to be stretched at least 100% and return essentially to the original dimension without imparting damage to the strap;
“exterior gas space” means the ambient atmospheric gas space into which exhaled gas enters after passing through and beyond the mask body and/or exhalation valve;
“exterior surface” means the surface of the mask body exposed to ambient atmospheric gas space when the mask body is positioned on the wearer's face;
“face seal” means a part(s) located between the mask body and a wearer's face at one or more locations where the mask body would otherwise contact the face;
“filtering face-piece” means that the mask body itself is designed to filter air that passes through it; there are no separately identifiable filter cartridges or insert-molded filter elements attached to or molded into the mask body to achieve this purpose;
“filter” or “filtration layer” means one or more layers of air-permeable material, which layer(s) is adapted for the primary purpose of removing contaminants (such as particles) from an air stream that passes through it;
“filter media” means an air-permeable structure that is designed to remove contaminants from air that passes through it;
“filtering structure” means a generally air-permeable construction that filters air;
“flat configuration” means the respirator is folded along the centerline such that it is flat as shown in FIG. 3;
“flat-fold” means that the respirator can be folded flat for storage and opened for use;
“folded inwardly” means being bent back towards the part from which it extends;
“harness” means a structure or combination of parts that assists in supporting the mask body on a wearer's face;
“integral” means being manufactured together at the same time; that is, being made together as one part and not two separately manufactured parts that are subsequently joined together;
“interior gas space” means the space between a mask body and a wearer's face;
“interior surface” means the surface of the mask body closest to a wearer's face when the mask body is positioned on the wearer's face;
“joined to” means secured to directly or indirectly;
“line of demarcation” means a fold, seam, weld line, bond line, stitch line, hinge line, and/or any combination thereof;
“mask body” means an air-permeable structure that is designed to fit over the nose and mouth of a wearer and that helps define an interior gas space separated from an exterior gas space (including the seams and bonds that join layers and parts thereof together);
“nose clip” means a mechanical device (other than a nose foam), which device is adapted for use on a mask body to improve the seal at least around a wearer's nose;
“nose region” means the portion of the mask body that resides over a wearer's nose when the respirator is worn;
“perimeter” means the outer edge of the mask body, which outer edge would be disposed generally proximate a wearer's face when the respirator is being donned by a person; a “perimeter segment” is a portion of the perimeter;
“pleat” means a portion that is designed to be or is folded back upon itself;
“polymeric” and “plastic” each means a material that mainly includes one or more polymers and that may contain other ingredients as well;
“respirator” means an air filtration device that is worn by a person to provide the wearer with clean air to breathe;
“side” means an area on the mask body distanced from a plane that bisects the mask body centrally and vertically when the mask body is oriented in an upright position and viewed from the front;
“sinus region” means the nose region and parts or areas of the mask body that reside beneath the wearer's eyes and/or eye orbitals when the respirator is being worn in a proper configuration;
“snug fit” or “fit snugly” means that an essentially air-tight (or substantially leak-free) fit is provided (between the mask body and the wearer's face);
“strap” means a generally flat elongated structure;
“tab” means a portion of a respirator that extends from the perimeter of the mask body of the respirator and is not a part of the breathable region of the respirator, i.e., in a non-breathable region of the respirator;
“transversely extending” means extending generally in the crosswise dimension; and
“vertical flat-fold respirator” means a respirator having a primary fold that is oriented vertically when the mask is viewed from the front in an upright position.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of a respirator.

FIG. 2 is a schematic front view of the respirator of FIG. 1.

FIG. 3 is a schematic right side view of the respirator of FIG. 1 when the respirator is in a flat configuration.

FIG. 4 is a schematic rear view of the respirator of FIG. 1.

FIG. 5 is a schematic cross-section view of a portion of a filtering structure.

FIG. 6 is a schematic plan view of an exterior surface of a mask body blank.

FIG. 7 is a schematic perspective view of one embodiment of a continuous process for manufacturing a respirator.

FIG. 8 is a schematic plan view of a mask body blank used in the process of FIG. 7.

### DETAILED DESCRIPTION

In general, the present disclosure provides various embodiments of respirators that include one or more tabs that extend from a perimeter of a mask body of the respirator. In one or more embodiments, a strap of a harness can be attached to the mask body at one or more strap attachment locations that are disposed on the one or more tabs. Further, the one or more tabs can be included with any suitable type of respirator.

Disposable respirators often rely on a fixed, elastic strap to secure the respirator to a wearer's head. Headbands for molded cup-shaped or flat-folded respirators can be designed to provide sufficient force to hold the respirator securely in place, while generating pressure within the “comfort zone” on users of various head or face sizes. Insufficient force can result in leakage around the perimeter of the respirator. Variations in the shape and stiffness of respirators, as well as the size and shape of users can make it challenging to determine a universal strap force value. For lightweight disposable respirators, a strap force value of 100-150 grams in a range of 20% to 300% elongation may, in one or more embodiments, be desirable.

To provide a harness strap with sufficient strap force to create an adequate respirator-to-face seal within the “comfort zone” of a largest class of users, manufacturers have generally chosen long strap segments constructed from materials with a low modulus. For example, harness straps are typically 15.2-35.6 mm (6-14 inches) in length. Common strap materials include natural rubber, polyisoprene, polyurethane, and natural and synthetic elastic braids or knits. The straps are generally longer than the distance between the strap attachment locations whether measured along an axis intersecting the strap attachment locations or as measured along a surface of the mask body blank. Straps having a length greater than the unit length between the attachment locations of the mask body blank are difficult to assembly on high speed manufacturing equipment for a number of reasons. For example, the slack or excess strap material can interfere with the movement of the mask body blanks along the production line. Further, compliant elastic strap materials can be difficult to handle on high-speed manufacturing equipment, and the greater the speed of the manufacturing equipment, the greater the degree of difficulty in registering the strap to the correct attachment locations.

Some elastomeric materials used for straps, such as natural rubber, are extremely sticky. These strap materials are frequently treated with talc or other powders to facilitate handling and to increase comfort for the user. The talc can accumulate, however, in the manufacturing equipment. Inconsistent or uneven application of the talc can create difficulties in handling the strap material. Finally, the process of using high speed manufacturing equipment can be further complicated by attaching multiple straps, such as a head strap and a neck strap, to a single mask body blank.

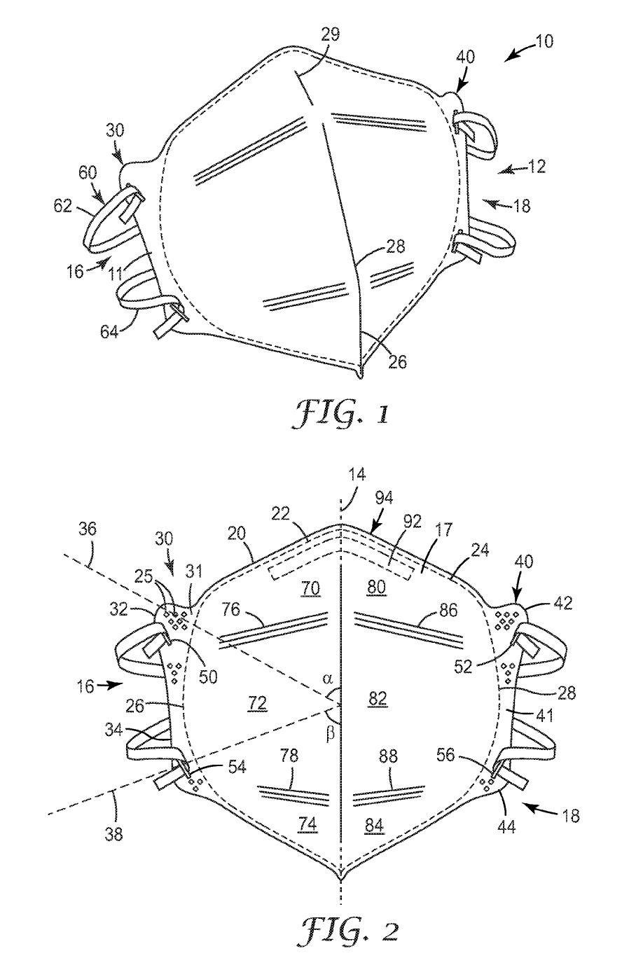

One or more embodiments of respirators of the present disclosure are configured such that first and/or second straps of a harness attached to the respirator do not include such excess material. For example, FIGS. 1-4 of the present disclosure illustrate one exemplary embodiment of a respirator 10. The respirator 10 can be any suitable respirator. In the illustrated embodiment, respirator 10 is a vertical flat-fold respirator. The respirator 10 includes a mask body 12 and a harness 60 attached to the mask body. As is further described herein, the harness 60 can include first and second straps 62, 64 that are attached to the mask body 12 at one or more attachment locations.

The mask body 12 includes a right portion 16 and a left portion 18. The right and left portions 16, 18 are positioned on each side of a centerline 14 of the mask body 12 (as shown in FIG. 2). The right and left portions 16, 18 are designated as such as viewed from a perspective of a wearer of the respirator 10 when the wearer is in an upright position. The right and left portions 16, 18 are bounded by a perimeter 24 of the mask body 12. In one or more embodiments, the perimeter 24 of the mask body 12 can include a weld line or fold that defines any suitable portion of the perimeter or the entire perimeter. Any suitable weld line or fold can be utilized. An edge 20 of the respirator 10 can also form at least a portion of the perimeter 24 of the mask body 12. In other words, the perimeter 24 can be defined by an edge 20 of the respirator 10, by a weld line, or by a combination of the edge of the respirator and a weld line. In one or more embodiments, the perimeter 24 can be adjacent the edge 20 of the respirator 10. The perimeter 24 of the mask body 12 can take any suitable shape or combinations of shapes.

The respirator 10 also includes a right tab 30 that extends from a right side perimeter segment 26 of the perimeter 24 of the mask body 12 adjacent the right portion 16, and a left tab 40 that extends from a left side perimeter segment 28 of the perimeter of the mask body adjacent the left portion 18. In one or more embodiments, one or both of the right tab 30 and left tab 40 can be integral with the mask body 12. In one or more alternative embodiments, one or both of the left and right tabs 16, 18 can be separately manufactured and then attached to the mask body 12 at the perimeter 24.

The right and left tabs 30, 40 can extend any suitable distance from the perimeter 24 of the mask body 12 to provide a width of each of the right and left tabs. In general, the widths of the right and left tabs 30, 40 can be increased to decrease a length of one or both of the first and second straps 62, 64. In other words, increasing the width of one or both tabs 30, 40 allows for the first and/or second attachment locations to be positioned a greater distance from the centerline 14. Shorter straps can, therefore, be accommodated by these attachment locations as a greater portion of a circumference around a head and/or neck of a wearer is traversed by the mask body 12 and the tabs 30, 40.

The right and left tabs 30, 40 can take any suitable shape or combination of shapes. For example, in the embodiment illustrated in FIGS. 1-4, the right tab 30 includes a first lobe 32 and a second lobe 34. The first and second lobes 32, 34 can take any suitable shape or combination of shapes and have any suitable dimensions. Further, in one or more embodiments, the first and second lobes 32, 34 can extend any suitable length from the perimeter 24 of the mask body 12. For example, in one or more embodiments, at least one of the first and second lobes 32, 34 extends at least 5 mm from the perimeter 24 of the mask body 12. Further, in one or more embodiments, at least one of the first and second lobes 32, 34 extends no greater than 55 mm from the perimeter 24 of the mask body 12.

In one or more embodiments, the first lobe 32 extends along a lobe axis 36 that forms any suitable angle α with the centerline 14 of the mask body 12. In one or more embodiments, α can be at least 0 degrees. In one or more embodiments, α can be no greater than 90 degrees. In one or more embodiments, α can be in a range of 45 to 85 degrees.

Further, in one or more embodiments, the second lobe 34 can extend along a second lobe axis 38 that forms any suitable angle β with centerline 14. In one or more embodiments, β can be at least 0 degrees. In one or more embodiments, β can be no greater than 90 degrees. In one or more embodiments, β can be in a range of 45 to 85 degrees.

Similarly, the left tab 40 can include a first lobe 42 and a second lobe 44. The first and second lobes 42, 44 include similar dimensions and properties as those described regarding first and second lobes 32, 34 of right tab 30.

In one or more embodiments, the right tab 30 and the left tab 40 can have the same shape and/or dimensions. In one or more alternative embodiments, the right tab 30 can take a different shape and/or have different dimensions than the left tab 40.

In one or more embodiments, the right and left tabs 30, 40 can be configured to overlay a zygomatic bone of a wearer. As used herein, “zygomatic bone” refers to a paired bone that articulates with the maxilla, the temporal bone, the sphenoid bone, and the frontal bone. The zygomatic bone is situated at an upper lateral part of the face of a wearer and informs the prominence of the cheek, part of the lateral wall and floor of the orbit, and parts of the temporal and in front temporal fossa. In one or more embodiments, one or both of the first lobe 32 of the right tab 30 and the first lobe 42 of the left tab 40 can be configured to overlay the zygomatic bone. The right and left tabs 30, 40 can overlay any portion of the zygomatic bone.

The right and left tabs 30, 40 of the present disclosure can also include additional features. For example, in one or more embodiments, one or both of the right and left tabs 30, 40 can include welds or bonds 25 provided thereon. In one or more embodiments, these welds or bonds 25 can provide any suitable functionality to the right and left tabs 30, 40. For example, in one or more embodiments, the welds or bonds 25 can increase a stiffness of one or both of the right and left tabs 30, 40. Any suitable technique or combination of techniques can be utilized to form welds 25.

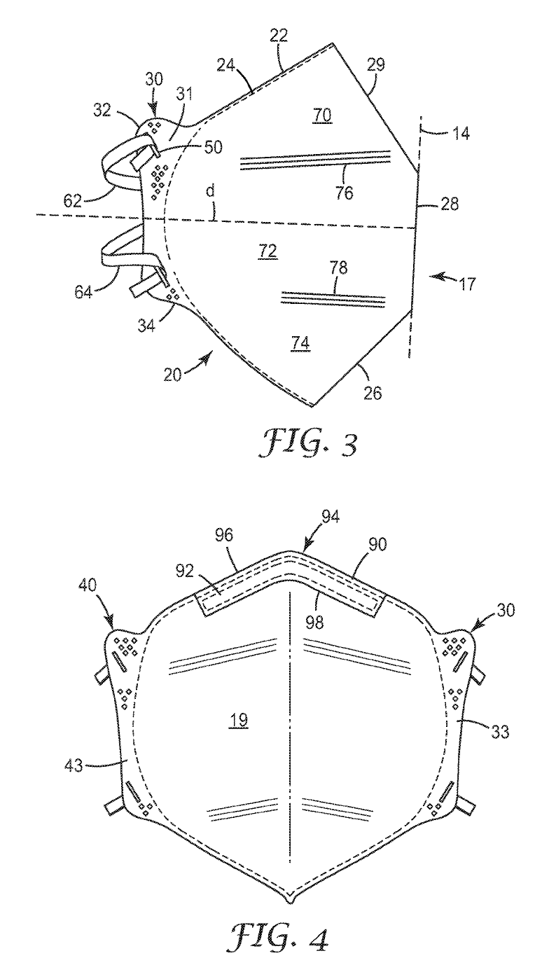

Attached to the mask body 12 is the harness 60, which can include any suitable harness that can hold the mask body in place on a face of a wearer. As illustrated in FIG. 1, the harness 60 includes the first (i.e., upper) strap 62 that is attached to the right and left tabs, 30, 40. The harness also includes the second (i.e., lower) strap 64 that is also attached to the right and left tabs 30, 40. The first and second straps 62, 64 can be attached to the right and left tabs 30, 40 on any surface of the tabs. For example, in the illustrated embodiment, the first and second straps 62, 64 are attached on an outer surface 31 of the right tab 30 and an outer surface 41 of the left tab 40 (as shown in FIG. 2). In one or more alternative embodiments, the first and second straps 62, 64 can be attached to an inner surface 33 of the right tab 30 and an inner surface 43 of the left tab 40 (such surfaces being illustrated in FIG. 4).

In one or more embodiments, the first strap 62 of the harness 60 is attached to the right tab 30 at first right attachment location 50 and to the left tab 40 at first left attachment location 52. Further, in one or more embodiments, the second strap 64 of the harness 60 can be attached to the right tab 30 at second right attachment location 54 and to the left tab 40 at second left attachment location 56. In one or more embodiments, the first and second attachment locations are disposed in a non-breathable region of the respirator 10 as is further described herein.

As mentioned herein, the first right and left attachment locations 50, 52 and the second right and left attachment locations 54, 56 can be disposed in any suitable location on right and left tabs 30, 40. As illustrated, the first right attachment location 50 is located on the first lobe 32 of right tab 30, and the first left attachment location 52 is located on the first lobe 42 of left tab 40. Further, the second right attachment location 54 is located on the second lobe 34 of right tab 30, and the second left attachment location 56 is located on the second lobe 44 of the left tab 40.

The first and second straps 62, 64 can be attached to the right and left tabs 30, 40 using any suitable technique or combination of techniques, e.g., thermal bonding, ultrasonic welding, adhering (e.g., using glues, adhesives, hot-melt adhesives, pressure sensitive adhesives, etc.), or mechanically fastening (e.g., using buckles, buttons and hooks, mating surface fasteners, or openings, such as loops or slots, formed at the left or right attachment locations for entrapping the strap material, etc.). The first and second straps 62, 64 can be attached to the right and left tabs 30, 40 such that the forces acting between the harness 60 and the mask body 12 when being worn by a wearer are in a peel mode or in a sheer mode. The harness 60 may be attached to the tabs 30, 40 between layers of the tab construction or on either outer or inner surface of the tabs as mentioned herein.

In general, the strap(s) that are used in the respirator harness can be expanded to greater than twice its total length and can be returned to its relaxed state many times throughout the useful life of the respirator. The strap also could possibly be increased to three or four times its relaxed state length and can be returned to its original condition without any damage thereto when the tensile forces are removed. In one or more embodiments, the elastic limit thus is not less than two, three, or four times the relaxed-state length of the strap(s). Typically, the strap(s) are about 20 to 32 cm long, 3 to 20 mm wide, and about 0.3 to 1 mm thick. The strap(s) may extend from the first side of the respirator to the second side as a continuous strap, or the strap may have a plurality of parts, which can be joined together by further fasteners or buckles. For example, the strap may have first and second parts that are joined together by a fastener that can be quickly uncoupled by the wearer when removing the mask body from the face. Alternatively, the strap may form a loop that is placed around the wearer's ears. See, e.g., U.S. Pat. No. 6,394,090 to Chen et al. Examples of fastening or clasping mechanisms that may be used to join one or more parts of the strap together are shown, e.g., in U.S. Pat. No. 6,062,221 to Brostrom et al. and U.S. Pat. No. 5,237,986 to Seppala; and in EP Patent Publication No. 1,495,785A1 to Chen. See also co-filed PCT Patent Application Serial No. ______ (Atty. Docket No. 75669WO003). The harness may also include a reusable carriage, one or more buckles, and/or a crown member to support the respirator on a person's head. See, e.g., U.S. Pat. Nos. 6,732,733 and 6,457,473 to Brostrom et al.; and U.S. Pat. Nos. 6,591,837 and 6,715,490 to Byram.

Each of the first and second straps 62, 64 has a length as measured between respective attachment locations along a surface of the strap. For example, the length of the first strap 62 is measured from first right attachment location 50 to first left attachment location 52 along a surface of the strap. And the length of the second strap 64 is measured from second right attachment location 54 to second left attachment location 56 along a surface of the strap. In one or more embodiments, the length of the first strap 62 is no greater than about 2 times a distance from either the first right or left attachment locations 50, 52 to the centerline 14. This distance from the attachment location to the centerline 14 can be measured in a direction orthogonal to the centerline 14 when the respirator 10 is in a flat configuration, i.e., the respirator is folded along centerline 14 such that the respirator is flat as shown in FIG. 3. For example, a distance d between the first right attachment location 50 and the centerline 14 can be measured along the outer surface 31 of the right tab and an outer surface 17 of the mask body 12 to the centerline 14, where the outer surface of the right tab and the outer surface of the mask body form a portion of an outer surface 11 of the respirator. In one or more embodiments, the first strap 62 can have a length of at least 20 cm. In one or more embodiments, the first strap 62 can have a length no greater than 32 cm. In one or more embodiments, the second strap 64 has a length that is no greater than about 2 times a distance from either the second right or left strap location 54, 56 to the centerline 14 as measured in a direction orthogonal to the centerline when the respirator 10 is in a flat configuration (as shown in FIG. 3). In one or more embodiments, the second strap 64 can have a length of at least 20 cm. In one or more embodiments, the second strap 64 can have a length no greater than 32 cm.

This is further illustrated in FIG. 6, which is a schematic plan view of an exterior surface 611 of a mask body blank 600 prior to central and lower panels being joined together along a centerline 614 to form any suitable respirator, e.g., respirator 10 of FIGS. 1-4 as is further described herein. In the embodiment illustrated in FIG. 6, first and second straps 662, 664 of harness 640 are attached to interior surfaces of right tab 630 and left tab 640. As can be seen in FIG. 6, a distance 602 from first right attachment location 650 on right tab 630 to centerline 614 is about half the length of a first strap 662 as measured between first right and left attachment locations 650, 652. Further, a distance 604 from first left attachment location 640 to the centerline 614 can also be about half the length of the first strap 662 as measured between first right and left attachment locations 650, 652. In other words, the first strap 662 can have a length that is no greater than about 2 times the distance between either first right attachment location 650 and the center line 614 (i.e., distance 602) or first left attachment location 652 and the center line 614 (i.e., distance 604) as measured along an axis 601 intersecting the first right and left attachment locations.

In one or more embodiments, a distance 606 from second right attachment location 654 on right tab 630 to centerline 614 is about half the length of a second strap 664 as measured between second right and left attachment locations 654, 656. Further, a distance 608 from second left attachment location 656 to the centerline 614 can also be about half the length of the second strap 664 as measured between second right and left attachment locations 654, 656. In other words, the second strap 664 can have a length that is no greater than about 2 times the distance between either second right attachment location 654 and the center line 614 (i.e., distance 606) or second left attachment location 656 and the center line 614 (i.e., distance 608) as measured along an axis 603 intersecting the second right and left attachment locations.

Because the length of the first strap 662 and the length of the second strap 664 are no greater in length than about the distance between attachment points, there is little or no slack in the headband material during manufacturing. In one or more embodiments, one or both of the first and second straps 662, 664 can have a length that is less than the distance between attachment locations such that any slack in the straps can be minimized during assembly.

Returning to FIGS. 1-4, the mask body 12 can include any suitable mask body through which inhaled air passes before entering the wearer's respiratory system. The mask body 12 can remove contaminants from the ambient environment so that the wearer can breathe filtered air. Further, the mask body 12 may take a variety of different shapes and configurations and typically is adapted so that it fits against the wearer's face or within a support structure that contacts the face.

In one or more embodiments, each of the right and left portions 16, 18 of the mask body 12 includes first and second lines of demarcation. For example, the right portion 16 of the mask body 12 includes a first line of demarcation 76 and a second line of demarcation 78, and the left portion 18 of the mask body includes a first line of demarcation 86 and a second line of demarcation 88. The first and second lines of demarcation can include any suitable structure that indicates separation between any two panels, e.g., bonded weld lines, folds, etc. Any suitable weld lines or lines can be utilized, e.g., as described in U.S. Pat. No. 8,528,560 to Duffy et al.

FIG. 2 shows a front view of respirator 10 in an open ready-to-use configuration. As can be seen in FIG. 2, the mask body 12 includes six filtration panels. Three of those panels are shown in FIG. 2 as right upper panel 70, right central panel 72, and right lower panel 74 (using the terms left, right, upper and lower in the wearer's sense). The remaining three panels are shown in FIG. 2 as left upper panel 80, left central panel 82, and left lower panel 84. The centerline 14 divides the right and left portions 16, 18 of the respirator 10. In one or more embodiments, upper panels 70, 80 are connected through a central vertical fold 29 (as shown in FIG. 3). Further, central panels 72, 82 are connected through a weld line 28 (also shown in FIG. 3). And lower panels 74, 84 are connected through a weld line 26 (also shown in FIG. 3).

In similar fashion, right upper and central panels 70, 72 are connected through weld line 76, right central and lower panels 72, 74 are connected through weld line 78, left upper and central panels 80, 82 are connected through weld line 86, and left central and lower panels 82, 84 are connected through weld line 88. One or more of panels 70, 72, 74, 80, 82, 84 may be provided as separate components.

Respirator 10 may be folded in half (e.g., for storage in a package prior to use or in a wearer's pocket) along the centerline 14 that, in this embodiment, corresponds to weld line 28 as shown in FIG. 3.

In one or more embodiments, the respirator 10 having a vertical fold line 29 substantially parallel to centerline 14 that connects the right and left upper panels 70, 80 can be considered a nose fold respirator. As used herein, the term “substantially parallel to centerline 14” means that the vertical fold line 29 forms an angle with the centerline 14 that is less than 10 degrees. In one or more embodiments, the respirator 10 can include a vertical fold line in place of the weld line 28 that connects the right and left center panels 72, 82 such that the respirator can be considered to be a central fold respirator. In such embodiments, the vertical fold line 29 can instead be a weld line along with weld line 26. Further, in one or more alternative embodiments, the weld line 26 can be replaced with a fold line such that the respirator can be considered to be a chin fold respirator. In such embodiments, the vertical fold line 29 can instead be a weld line along with weld line 28. Any suitable technique or combination of techniques can be utilized to provide the fold lines and weld lines as is further described herein. Further, in one or more embodiments, the right portion 16 and left portion 18 can be separate portions that are joined together at weld lines 29, 28, and 26.

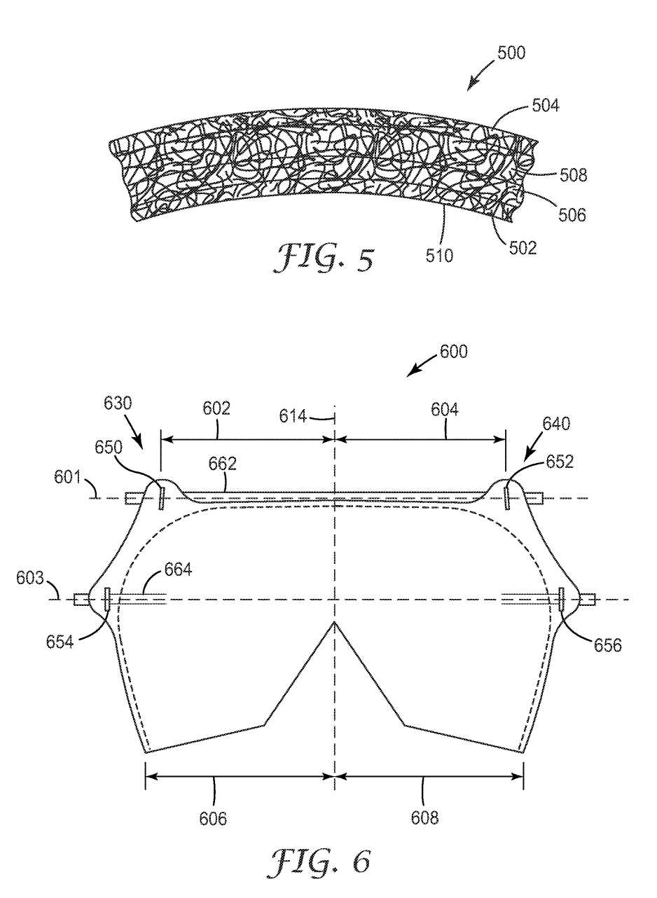

In one or more embodiments, the mask body 12 can include a filtering structure. Any suitable filtering structure can be utilized. For example, FIG. 5 is a schematic cross-section view of a portion of a filtering structure 500 that can be utilized in the mask body 12 of respirator 10. The filtering structure that is used in connection with respirators suitable for use in connection with the present disclosure may take on a variety of different shapes and configurations. As shown in FIG. 5, the filtering structure 500 may have a plurality of layers, including a fibrous filtration layer 508, and one or more fibrous cover webs 502 (i.e., an inner cover web) and 504 (i.e., an outer cover web). When the respirator is a molded mask, the mask body may also include a shaping layer 506. See, e.g., U.S. Pat. No. 6,923,182 to Angadjivand et al.; U.S. Pat. No. 7,131,442 to Kronzer et al.; U.S. Pat. Nos. 6,923,182 and 6,041,782 to Angadjivand et al.; U.S. Pat. No. 4,807,619 to Dyrud et al.; and U.S. Pat. No. 4,536,440 to Berg. In general, the filtering structure removes contaminants from the ambient air and may also act as a barrier layer that precludes liquid splashes from entering the mask interior. The outer cover web can act to stop or slow any liquid splashes, and the inner filtering structure may then contain them if there is penetration past the other layers. The filtering structure can be of a particle capture or gas and vapor type filter. The filtering structure may include multiple layers of similar or dissimilar filter media and one or more cover webs as the application requires. If the respirator contains a fluid impermeable mask body that has one or more filter cartridges attached to it. See, e.g., U.S. Pat. No. 6,874,499 to Viner et al.; U.S. Pat. Nos. 6,277,178 and D613,850 to Holmquist-Brown et al.; RE39,493 to Yuschak et al.; D652,507, D471,627, and D467,656 to Mittelstadt et al.; and D518,571 to Martin.

The cover webs 502, 504 may be located on the outer sides of the filtering structure 500 to capture any fibers that could come loose therefrom. Typically, the cover webs 502, 504 are made from a selection of fibers that provide a comfortable feel, particularly on a side 510 of the filtering structure 500 that makes contact with the wearer's face. The constructions of various filter layers, shaping layers, and cover webs that may be used in conjunction with a filtering structure used in a respirator of the present disclosure are described herein in more detail.

Filters that may be beneficially employed in a respirator of the present disclosure are generally low in pressure drop (for example, less than about 195 to 295 Pascals at a face velocity of 13.8 centimeters per second) to minimize the breathing work of the mask wearer. Filtration layers additionally are flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged provide particular utility for particulate capture applications.

The filtration layer is typically chosen to achieve a desired filtering effect. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area. See, e.g., U.S. Pat. Nos. 5,804,295 and 5,656,368 to Braun et al. The filtration layer also may include multiple filtration layers joined together by an adhesive or any other techniques. Essentially any suitable material that is known (or later developed) for forming a filtering layer may be used as the filtering material. Webs of melt-blown fibers, such as those taught in Wente, Van A., Superfine Thermoplastic Fibers, 48 Indus. Eng. Chem., 1342 et seq. (1956), especially when in a persistent electrically charged (electret) form are especially useful (see, e.g., U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Electrically charged fibrillated-film fibers as taught in U.S. Patent Re. 31,285 to van Turnhout also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al.; U.S. Pat. No. 6,783,574 to Angadjivand et al.; U.S. Pat. No. 6,743,464 to Insley et al.; U.S. Pat. Nos. 6,454,986 and 6,406,657 to Eitzman et al.; and U.S. Pat. Nos. 6,375,886 and 5,496,507 to Angadjivand et al. Electric charge also may be imparted to the fibers by corona charging as disclosed in U.S. Pat. No. 4,588,537 to Klasse et al., or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment. See, e.g., U.S. Pat. Nos. 6,398,847 B1, 6,397,458 B1, and 6,409,806 B1 to Jones et al. Typical basis weights for electret BMF filtration layers are about 10 to 100 grams per square meter (g/m²). When electrically charged according to techniques described in, e.g., the '507 Angadjivand et al. Patent, and when including fluorine atoms as mentioned in the Jones et al. Patents, the basis weight may be about 20 to 40 g/m² and about 10 to 30 g/m², respectively. Additionally, sorptive materials such as activated carbon may be disposed between the fibers and/or various layers that include the filtering structure. Further, separate particulate filtration layers may be used in conjunction with sorptive layers to provide filtration for both particulates and vapors. The sorbent component may be used for removing hazardous or odorous gases from the breathing air. Sorbents may include powders or granules that are bound in a filter layer by adhesives, binders, or fibrous structures. See, e.g., U.S. Pat. No. 6,334,671 to Springett et al. and U.S. Pat. No. 3,971,373 to Braun. A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtering structure that may be conformed into various configurations is described in U.S. Pat. No. 6,391,429 to Senkus et al.

The cover webs also may have filtering abilities, although typically not nearly as good as the filtering layer and/or may serve to make a filtering face-piece respirator more comfortable to wear. The cover webs may be made from nonwoven fibrous materials such as spun bonded fibers that contain, e.g., polyolefins, and polyesters. See, e.g., U.S. Pat. No. 6,041,782 to Angadjivand et al.; U.S. Pat. No. 4,807,619 to Dyrud et al.; and U.S. Pat. No. 4,536,440 to Berg. When a wearer inhales, air is drawn through the mask body, and airborne particles become trapped in the interstices between the fibers, particularly the fibers in the filter layer.

The inner cover web can be used to provide a smooth surface for contacting the wearer's face. Further, the outer cover web, in addition to providing splash fluid protection, can be used for entrapping loose fibers in the mask body and for aesthetic reasons. The cover web typically does not provide any substantial filtering benefits to the filtering structure, although it can act as a pre-filter when disposed on the exterior of (or upstream to) the filtration layer. To obtain a suitable degree of comfort, an inner cover web can have a comparatively low basis weight and can be formed from comparatively fine fibers. More particularly, the cover web may be fashioned to have a basis weight of about 5 to 70 g/m² (typically 10 to 30 g/m²), and the fibers may be less than 3.5 denier (typically less than 2 denier, and more typically less than 1 denier but greater than 0.1 denier). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web may be blown microfiber (BMF) materials, particularly polyolefin BMF materials, e.g., polypropylene BMF materials (including polypropylene blends and also blends of polypropylene and polyethylene). And an exemplary process for producing BMF materials for a cover web is described in U.S. Pat. No. 4,013,816 to Sabee et al. The web may be formed by collecting the fibers on a smooth surface, typically a smooth-surfaced drum or a rotating collector. See, e.g., U.S. Pat. No. 6,492,286 to Berrigan et al. Spun-bond fibers also may be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m²and having a fiber denier in the range 0.2 to 3.1 (with an average, measured over 100 fibers of about 0.8). Another suitable fiber is a polypropylene/polyethylene BMF (produced from a mixture comprising 85% of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available under the trade designations “Corosoft Plus 20,” “Corosoft Classic 20” and “Corovin PP S 14,” from Corovin GmbH of Peine, Germany, and a carded polypropylene/viscose material available, under the trade designation “370/15,” from J. W. Suominen OY of Nakila, Finland. Cover webs typically have very few fibers protruding from the web surface after processing and therefore have a smooth outer surface. Examples of cover webs that may be used in a respirator of the present disclosure are described, e.g., in U.S. Pat. No. 6,041,782 to Angadjivand; U.S. Pat. No. 6,123,077 to Bostock et al.; and PCT Publication No. WO 96/28216A to Bostock et al.

In one or more embodiments, one or both of the inner cover web 502 and outer cover web 504 can include a polymeric netting. Any suitable polymeric netting described herein can be utilized for one or both cover webs. The netting may be made from a variety of polymeric materials. Polymers suitable for netting formation are thermoplastic materials. Examples of thermoplastic polymers that can be used to form polymer netting of the present invention include polyolefins (e.g., polypropylene and polyethylene), polyethylene-vinyl acetate (EVA), polyvinyl chloride, polystyrene, nylons, polyesters (e.g., polyethylene terephthalate), and elastomeric polymers, (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Blends of two or more materials also may be used in the manufacture of nettings. Examples of such blends include polypropylene/EVA and polyethylene/EVA. Polypropylene may be preferred for use in the polymeric netting since melt-blown fibers are regularly made from polypropylene. Use of similar polymers enables proper welding of the support structure to the filtering structure.

The shaping layer(s) may be formed from at least one layer of fibrous material that can be molded to the desired shape with the use of heat and that retains its shape when cooled. Shape retention is typically achieved by causing the fibers to bond to each other at points of contact between them, for example, by fusion or welding. Any suitable material known for making a shape-retaining layer of a direct-molded respiratory mask may be used to form the mask shell, including, for example, a mixture of synthetic staple fiber, e.g., crimped, and bicomponent staple fiber. Bicomponent fiber is a fiber that includes two or more distinct regions of fibrous material, typically distinct regions of polymeric materials. Typical bicomponent fibers include a binder component and a structural component. The binder component allows the fibers of the shape-retaining shell to be bonded together at fiber intersection points when heated and cooled. During heating, the binder component flows into contact with adjacent fibers. The shape-retaining layer can be prepared from fiber mixtures that include staple fiber and bicomponent fiber in a weight-percent ratios that may range, for example, from 0/100 to 75/25. In one or more embodiments, the material includes at least 50 weight-percent bicomponent fiber to create a greater number of intersection bonding points, which, in turn, increase the resilience and shape retention of the shell.

Suitable bicomponent fibers that may be used in the shaping layer include, for example, side-by-side configurations, concentric sheath-core configurations, and elliptical sheath-core configurations. One suitable bicomponent fiber is the polyester bicomponent fiber available, under the trade designation “KOSA T254” (12 denier, length 38 mm), from Kosa of Charlotte, N.C., U.S.A., which may be used in combination with a polyester staple fiber, for example, that is available from Kosa under the trade designation “T259” (3 denier, length 38 mm) and possibly also a polyethylene terephthalate (PET) fiber, for example, that available from Kosa under the trade designation “T295” (15 denier, length 32 mm). Alternatively, the bicomponent fiber may include a generally concentric sheath-core configuration having a core of crystalline PET surrounded by a sheath of a polymer formed from isophthalate and terephthalate ester monomers. The latter polymer is heat softenable at a temperature lower than the core material. Polyester has advantages in that it can contribute to mask resiliency and can absorb less moisture than other fibers.

Alternatively, the shaping layer can be prepared without bicomponent fibers. For example, fibers of a heat-flowable polyester can be included together with, e.g., stapled, crimped, fibers in a shaping layer so that, upon heating of the web material, the binder fibers can melt and flow to a fiber intersection point where it forms a mass that upon cooling of the binder material, creates a bond at the intersection point. Staple fibers (for the shaping component) that are pre-treated with Ammonium Polyphosphate type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

When a fibrous web is used as the material for the shape-retaining shell, the web can be conveniently prepared on a “Rando Webber” air-laying machine (available from Rando Machine Corporation, Macedon, N.Y.) or a carding machine. The web can be formed from bicomponent fibers or other fibers in conventional staple lengths suitable for such equipment. To obtain a shape-retaining layer that has the required resiliency and shape-retention, the layer can have a basis weight of at least about 100 g/m², although lower basis weights are possible. Higher basis weights, for example, approximately 150 or more than 200 g/m², may provide greater resistance to deformation and greater resiliency and may be more suitable if the mask body is used to support an exhalation valve. Together with these minimum basis weights, the shaping layer typically has a maximum density of about 0.2 g/cm² over the central area of the mask. Typically, the shaping layer would have a thickness of about 0.3 to 2.0, more typically about 0.4 to 0.8 millimeters. Examples of shaping layers suitable for use in the present disclosure are described, e.g., U.S. Pat. No. 5,307,796 to Kronzer et al.; U.S. Pat. No. 4,807,619 to Dyrud et al.; and U.S. Pat. No. 4,536,440 to Berg. Staple fibers (for the shaping component) that are pre-treated with Ammonium Polyphosphate type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

As mentioned herein, the right and left tabs 30, 40 can be made such that they are integral with the mask body 12 and, therefore, can include the same layer or layers and materials as the mask body. For example, one or both of the right and left tabs 30, 40 can include at least one of an outer cover web, a filtration layer, a shaping layer, and an inner cover web. In one or more embodiments, one or both of the right tab 30 and the left tab 40 does not include one or more of these layers. For example, in one or more embodiments, the filtration layer of the filtering structure of the mask body 12 may not extend from the mask body into one or both tabs 30, 40. Instead, the filtration layer may terminate at the perimeter 24 of the mask body 12. Alternatively, the filtration layer may extend beyond the perimeter 24 into only a portion of one or both of the tabs 30, 40.

In general, the perimeter 24 of the mask body 12 distinguishes the mask body from the right and left tabs 30, 40. At least a portion of the perimeter 24 of the mask body 12 may contact a face of a wearer and provide a seal between the respirator 10 and the face. In such embodiments, the left and right tabs 30, 40 do not form a part of the breathable region of the respirator 10. In other words, substantially all of the air passing through the respirator 10 passes through the mask body 12 and not the left and right tabs 30, 40. The mask body, therefore, forms a breathable region of the respirator 10, and the right and left tabs 30, 40 form a non-breathable region of the respirator.

Although a filtering face-piece respirator has been illustrated in the present disclosure, the respirator may include a compliable rubber-type mask that has one or more filter cartridges attached to it. See, e.g., U.S. Pat. No. RE 39,493 to Yuschak et al. and U.S. Pat. No. 7,650,884 to Flannigan et al. Or it could be a full face respirator. See, e.g., U.S. Pat. No. 8,067,110 to Rakow et al.; U.S. Pat. No. 7,594,510 to Betz et al.; and D421,118 and D378,610 to Reischel et al.

In one or more embodiments, an exhalation valve (not shown) may be attached to the mask body 12 to facilitate purging exhaled air from the interior gas space. The use of an exhalation valve may improve wearer comfort by rapidly removing the warm moist exhaled air from the mask interior. See, e.g., U.S. Pat. Nos. 7,188,622; 7,028,689, and 7,013,895 to Martin et al.; U.S. Pat. Nos. 7,428,903; 7,311,104; 7,117,868; 6,854,463; 6,843,248; and 5,325,892 to Japuntich et al.; U.S. Pat. Nos. 7,302,951 and 6,883,518 to Mittelstadt et al.; and RE 37,974 to Bowers. Essentially any exhalation valve that provides a suitable pressure drop and that can be properly secured to the mask body 12 may be used in connection with the present disclosure to rapidly deliver exhaled air from the interior gas space to the exterior gas space.

Further, in one or more embodiments, the mask body 12 can include a nose clip 92 (as shown in FIG. 4). Any suitable nose clip 92 can be utilized. In one or more embodiments, the nose clip 92 may be essentially any additional part that assists in improving the fit over the wearer's nose. Because the wearer's face exhibits a major change in contour in the nose region, a nose clip may be used to better assist in achieving the appropriate fit in this location. The nose clip may include, for example, a pliable dead soft band of metal such as aluminum, which can be shaped to hold the mask in a desired fitting relationship over the nose of the wearer and where the nose meets the cheek. The nose clip may be linear in shape when viewed from a plane projected onto the mask body when in its folded or partially folded condition. Alternatively, the nose clip can be an M-shaped nose clip, an example of which is shown in U.S. Pat. Nos. 5,558,089 and Des. 412,573 to Castiglione. Other exemplary nose clips are described in U.S. Pat. No. 8,066,006 to Daigard et al.; U.S. Pat. No. 8,171,933 to Xue et al.; and U.S. Patent Publication No. 2007-0068529A1 to Kalatoor et al.

In one or more embodiments, the nose clip 92 can be disposed adjacent an upper perimeter segment 22 of the perimeter 24 of the mask body 12. The nose clip 92 can be disposed on an outer most surface 17 (i.e., exterior surface) of the mask body 12, e.g., on an outer cover web of the filtering structure of the mask body 12. The nose clip 92 can be disposed on the outermost surface 17 using any suitable technique or combination of techniques. For example, the nose clip 92 can be attached to the outermost surface 17 using, e.g., adhesives, etc. Alternatively, in one or more embodiments, the nose clip 92 can be disposed between an outer cover web and an interior layer, e.g., a filtration layer. The nose clip 92 can be disposed between the outer cover web and the filtration layer using any suitable technique or combination of techniques, e.g., welding the outer cover web to the filtration layer in a pattern adjacent the nose clip such that the nose clip is secured in place between the outer cover web and the filtration layer.

In the embodiment illustrated in FIGS. 1-4, a portion of the mask body 90 is folded over upon itself in a nose region 94 of the mask body to form a fold 96 that intersects the centerline 14 (as shown in FIG. 4). In the illustrated embodiment, the portion 90 of the mask body 12 that is folded over is attached to the interior surface 19 of the mask body 12. In one or more alternative embodiments, the portion 90 of the mask body 12 can be folded over onto the exterior surface 17 of the mask body 12. The portion of the mask body 90 that is folded over can be attached to the mask body 12 using any suitable technique or combination of techniques, e.g., welding, adhering, fastening, etc. For example, an edge 98 of the folded portion 90 can be attached to the mask body 12, e.g., by welding the edge to the mask body.

In one or more embodiments, portion 90 can provide a cushion between the nose clip 92 and the wearer's face as is described, e.g., in U.S. Patent Publication No. 2011/0315144 to Eitzman et al. The folded portion 90 can be used instead of or in addition to a nose foam and can provide additional comfort to a wearer while providing a snug fit over the nose.

The various embodiments of respirators described herein can be manufactured using any suitable technique or combination of techniques. See, e.g., U.S. Pat. No. 6,148,817 to Bryant et al.; U.S. Pat. No. 6,722,366 to Bostock et al.; and U.S. Pat. No. 6,394,090 to Chen et al. In general, a flat-folded respirator, e.g., respirator 10 of FIGS. 1-4, can be formed from a single piece, although multiple pieces can be attached to one another using the various techniques described herein, such as a batch process (e.g., by plunge welding) or a continuous process (e.g., rotary welding). In either process, a flat-folded respirator can be manufactured by forming a substantially flat sheet of a multilayer construction (also referred to herein as a “mask body blank”) by bonding and cutting the outer forming edges. Other techniques may be employed for forming the edges utilizing other techniques, such as ultrasonic welding, stitching, and the application of pressure to form the edges (with or without the addition of heat).

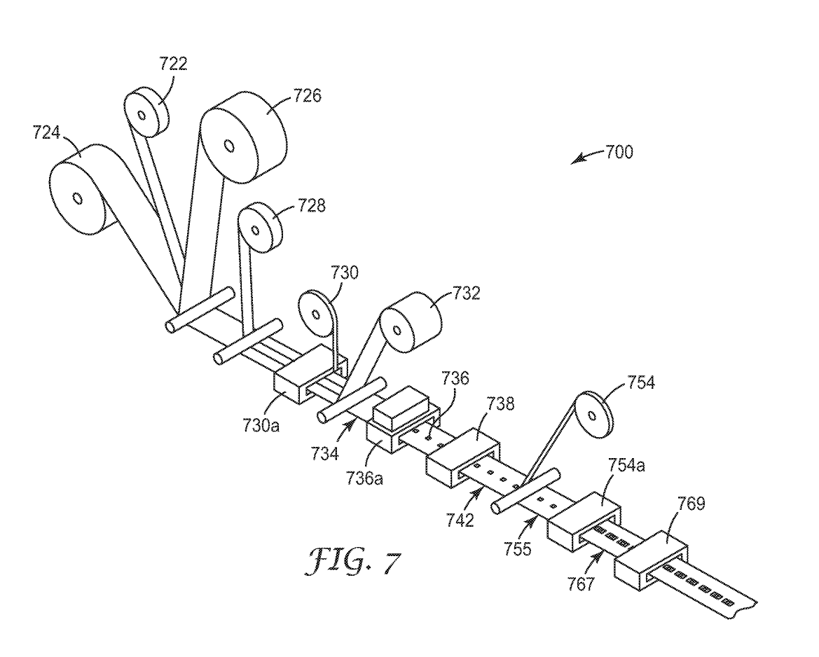

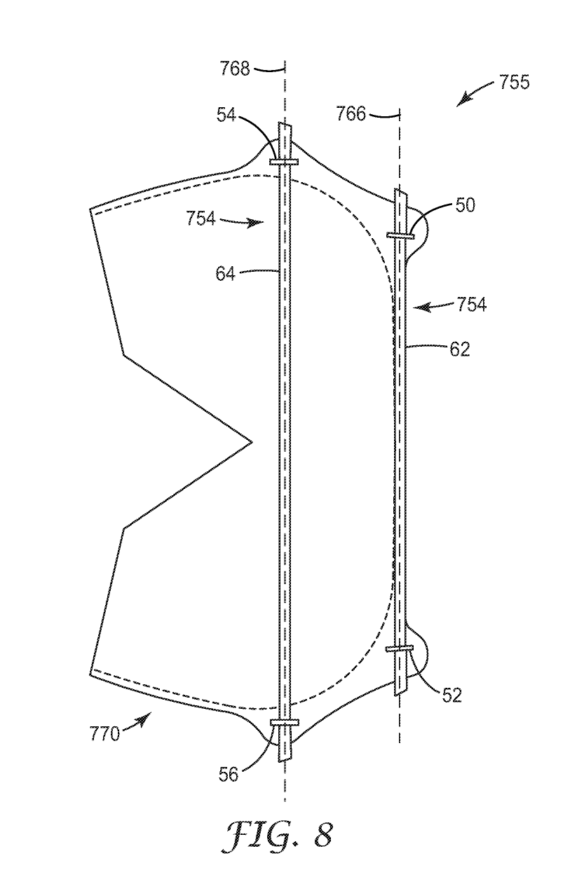

For example, FIGS. 7-8 illustrate one embodiment of a process 700 for making a flat fold respirator. In one or more embodiments, the process can be continuous, i.e., the respirator can be manufactured along a manufacturing line without the need to remove the respirator from the line prior to the completion of the process. Although the continuous process 700 is described in reference to the respirator 10 as illustrated in FIGS. 1-4, the process can be utilized to manufacture any flat-fold respirator. A foam portion 722 is optionally positioned between an inner cover web 724 and a filtration layer 726. In one or more embodiments, the foam portion 722 and/or nose clip 730 may be positioned on an outer surface of either an inner cover web 724 or an outer cover web 732. A reinforcing material 728 is optionally positioned proximate a center on the filtration layer 726. A nose clip 730 is optionally positioned along one edge of the filtration layer 726 proximate the reinforcing material 728 at a nose clip application station 730a. In one or more embodiments, the nose clip 730 is disposed on the filtration layer 726 adjacent the upper perimeter segment as is further described herein. The filtration layer 726, reinforcing material 728 and nose clip 730 are covered by the outer cover web 732 to form a web assembly 734. The web assembly 734 may be held together by surface forces, electrostatic forces, thermal bonding, or an adhesive.

An exhalation valve 736 is optionally inserted into the web assembly 734 at a valving station 736a. The valving station 736a can form a hole proximate the center of the web assembly 734. The edges of the hole may be sealed to minimize excess web material. The valve 736 may be retained in the hole by welding, adhesive, pressure fit, clamping, snap assemblies or some other suitable means.

The web assembly 734 is welded and, in one or more embodiments, can be trimmed along a perimeter (e.g., perimeter 24 of respirator 10) at face fit station 738. Other welds or bondlines can be formed at station 738, e.g., first lines of demarcation 76, 86, second lines of demarcation 78, 88, welds or bonds 25 on one or both of right and left tabs 30, 34, and welds formed by welding the portion of the mask body 90 that is folded over on itself. Any suitable technique or combination of techniques can be utilized to form these and other welds on the mask body 12 and tabs 30, 40.

The excess web material is removed to form one or more mask body blanks 755. An exterior surface 770 of a mask body blank 755 is also shown in FIG. 8. Such mask body blank 755 can be utilized to form respirator 10 of FIGS. 1-4. As stated herein, the portion of the mask body blank (portion 90 of respirator 10) is folded over upon itself in a nose region of the mask body blank 755 (not shown). An edge of the folded portion of the mask body blank 755 can be attached to the mask body blank using any suitable technique or combination of techniques.

At station 754a, strap material 754 forming the first strap 62 is positioned on the mask body blank 755 along a first strap path 766 extending between first right and left attachment locations 50, 52, and additional strap material 754 forming the second strap 64 is positioned on the mask body blank 755 along a second strap path 768 extending between second right and left attachment locations 54, 56 as shown in FIG. 8. The first strap 62 is attached to the mask body blank 755 at first right and left attachment locations 50, 52, and the second strap 64 is attached to the mask body blank 755 at second right and left strap locations 54, 56. Since the mask body blank 755 is substantially flat during the manufacturing process 700, the first and second strap paths 766, 768 are axes that substantially intersect the first right and left attachment locations 52, 54 and second right and left attachment locations 56, 58 respectively. The first and second straps 62, 64 can be formed either before or after any excess web material is removed to form one or more mask body blanks 755.

An advantage of at least one embodiment of the respirators described herein is that the lengths of tabs 30, 40 can be adjusted to allow for the use of different lengths of straps 62, 64 while still taking advantage of the ability to attach the straps when the mask body blank is in a flat configuration (e.g., as shown in FIG. 3). In many current techniques for attaching straps to vertical fold respirators, the mask is fully constructed prior to attaching the straps. The respirator must then be unfolded and placed on a mandrel, which holds the mask in an open position, while the straps are attached. This process can typically only be done in a manual or semi-automated process. As is described herein, by applying straps to a vertical fold mask while the mask body blank is substantially flat, the straps can be attached as part of a fully automated or continuous process.

It will be understood that it is possible to activate or partially activate the headband material 754 before, during or after application to the mask body blank 755. In one or more embodiments, the headband material 754 is activated just prior to application by selectively clamping the yet unactivated headband material between adjacent clamps, elongating it the desired amount, laying the activated headband material 754 onto the mask body blank 755, and attaching the inactivated end portions of the headband material 754 to the blank 755. Alternatively, the unactivated headband material 754 can be laid onto the mask body blank 755, attached at the ends as discussed herein and then activated prior to packaging. Finally, the headband material 754 can remain unactivated until activated by the user.

At folding station 769, the blanks 755 are folded along vertical fold line 29 (as shown in FIG. 3), and the right and left central panels 72, 82 are connected by welding the panels together to form a weld line 28. And in one or more embodiments, the right and left lower panels 74, 84 can be connected by welding the panels together to form weld line 26 (as also shown in FIG. 3). Further, any additional excess web material can be removed from the blanks 755 following folding and welding at folding stations 769.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A vertical flat-fold respirator comprising:
a harness comprising first and second straps;
a mask body comprising right and left portions on each side of a centerline, wherein the right and left portions are bounded by a perimeter of the mask body;
a right tab that extends from a right side perimeter segment of the perimeter of the mask body adjacent the right portion, and a left tab that extends from a left side perimeter segment of the perimeter of the mask body adjacent the left portion;
wherein the first strap of the harness is attached to the right and left tabs at first right and left attachment locations, and the second strap is attached to the right and left tabs at second right and left attachment locations; and
wherein a length of the first strap is no greater than about two times a distance from either the first right or left attachment locations to the centerline as measured in a direction orthogonal to the centerline when the respirator is in a flat configuration.

2. The respirator of claim 1, wherein a length of the second strap is no greater than about two times a distance from either the second right or left attachment locations to the centerline as measured in a direction orthogonal to the centerline when the respirator is in a flat configuration.

3. The respirator of claim 2, wherein the length of the first strap is equal to the length of the second strap.

4. The respirator of claim 1, wherein the right tab comprises first and second lobes that extend away from the right perimeter segment of the mask body, wherein the first right attachment location is disposed on the first lobe of the right tab and the second right attachment location is disposed on the second lobe of the right tab.

5. The respirator of claim 4, wherein the left tab comprises first and second lobes that extend away from the left perimeter segment of the mask body, wherein the first left attachment location is disposed on the first lobe of the left tab and the second left attachment location is disposed on the second lobe of the left tab.

6. The respirator of claim 5, wherein the first lobe of each of the right and left tabs is configured to overlay a zygomatic bone of a wearer.

7. The respirator of claim 1, wherein the right and left tabs are integral with the mask body.

8. The respirator of claim 1, wherein the right and left tabs are attached to the mask body.

9. The respirator of claim 1, wherein the perimeter of the mask body is defined by a weld line.

10. The respirator of claim 1, further comprising a nose clip disposed adjacent an upper perimeter segment of the perimeter of the mask body, wherein a portion of the mask body is folded over upon itself in a nose region of the mask body to form a fold that intersects the centerline.

11. The respirator of claim 1, wherein the mask body further comprises a filtering structure comprising an inner cover web, a filtration layer, and an outer cover web, wherein the filtration layer is disposed between the inner cover web and the outer cover web.

12. The respirator of claim 1, wherein each of the right and left tabs comprises welds provided thereon to increase a stiffness of the right and left tabs.

13. The respirator of claim 1, wherein each of the right and left portions of the mask body comprises an upper panel, a central panel, and a lower panel, wherein the upper panel and central panel are separated by a first line of demarcation, and further wherein the central panel and the lower panel are separated by a second line of demarcation.

14. The respirator of claim 13, wherein the upper panel of the right portion and the upper panel of the left portion are connected through a vertical fold.

15. The respirator of claim 14, wherein the central panel of the right portion and the central panel of the left portion are connected through a weld line.

16. The respirator of claim 15, wherein the lower panel of the right portion and the lower panel of the left portion are connected through an additional weld line.

17. The respirator of claim 13, wherein each of the first and second lines of demarcation comprises a weld line.

18. A continuous process for making a vertical flat-fold respirator, comprising:
forming a mask body blank, wherein the mask body blank comprises:
right and left portions on each side of a centerline, wherein the right and left portions are bounded by a perimeter of the mask body blank;
a right tab that extends from a right side perimeter segment of the perimeter of the mask body blank adjacent the right portion, and a left tab that extends from a left side perimeter segment of the perimeter of the mask body blank adjacent the left portion;
first and second right attachment locations disposed on the right tab; and
first and second left attachment locations disposed on the left tab;
wherein the first right attachment location and the first left attachment location define a first strap path, and further wherein the second right attachment location and the second left attachment location form a second strap path;
positioning a first strap along the first strap path and a second strap along the second strap path;
attaching the first strap to the first right and left attachment locations; and
attaching the second strap to the second right and left attachment locations;
wherein a length of the first strap is no greater than about two times a distance from either the first right or left attachment locations to the centerline as measured in a direction orthogonal to the center line when the respirator is in a flat configuration.

19. The continuous process of claim 18, further comprising attaching a nose clip to the mask body blank adjacent an upper perimeter segment of the perimeter of the mask body blank.

20. The continuous process of claim 19, further comprising:
folding a portion of the mask body blank over upon itself in a nose region of the mask body blank; and
attaching an edge of the folded portion of the mask body blank to the mask body blank.
